(19) United States
(12) Patent Application Publication
(10) Pub. No.: US 2023/0104491 A1
(43) Pub. Date: Apr. 6, 2023

(54) SMALL AND FAST TRANSFORMER WITH SHARED DICTIONARY

(71) Applicant: Samsung Electronics Co., Ltd., Suwon-si (KR)

(72) Inventors: Qian Lou, Oviedo, FL (US); Yilin Shen, San Jose, CA (US); Hongxia Jin, San Jose, CA (US); Ting Hua, Cupertino, CA (US); Yen-Chang Hsu, Fremont, CA (US)

(21) Appl. No.: 17/934,445

(22) Filed: Sep. 22, 2022

Related U.S. Application Data
(60) Provisional application No. 63/252,501, filed on Oct. 5, 2021.

(51) Int. Cl. G06N 5/00

(52) U.S. Cl. CPC G06N 5/003

(57) ABSTRACT

A method includes receiving one or more training corpora for training a machine learning model having a plurality of encoder blocks, where each encoder block includes an attention layer and a feedforward network. The method also includes using the one or more training corpora to train an attention dictionary shared across the plurality of encoder blocks. Training the attention dictionary may include training attention parameters of the attention layer in each of the plurality of encoder blocks, and the attention parameters for a given encoder block among the plurality of encoder blocks may be a weighted combination of columns from the attention dictionary shared across the plurality of encoder blocks.

### CROSS-REFERENCE TO RELATED APPLICATION AND PRIORITY CLAIM

This application claims priority under 35 U.S.C. § 119(e) to U.S. Provisional Patent Application No. 63/252,501 filed on Oct. 5, 2021. This provisional application is hereby incorporated by reference in its entirety.

### TECHNICAL FIELD

This disclosure relates generally to machine learning systems. More specifically, this disclosure relates to a small and fast transformer with a shared dictionary.

### BACKGROUND

Machine learning-based technologies are being used more and more often in many different applications, such as imaging, natural language processing (NLP), computer vision (CV), beam steering, and the like. Many mobile electronic devices, such as smartphones and tablet computers, include or utilize machine learning models or other technologies that have been developed to provide such features. However, one challenge involves model size. A transformer with increasing model size often results in improved performance, but the increasing model size is not realistic in many applications due to hardware memory limitations and long inference/training times. Also, analysis has found that existing transformers are usually over-parameterized. An over-parameterized transformer is usually inevitable in certain machine learning models.

### SUMMARY

This disclosure relates to a small and fast transformer with a shared dictionary.

In a first embodiment, a method includes receiving one or more training corpora for training a machine learning model having a plurality of encoder blocks, where each encoder block includes an attention layer and a feedforward network. The method also includes using the one or more training corpora to train an attention dictionary shared across the plurality of encoder blocks.

In a second embodiment, an apparatus includes at least one processing device configured to receive one or more training corpora for training a machine learning model having a plurality of encoder blocks, where each encoder block includes an attention layer and a feedforward network. The at least one processing device is also configured to use the one or more training corpora to train an attention dictionary shared across the plurality of encoder blocks.

In a third embodiment, a non-transitory computer readable medium contains instructions that, when executed by at least one processor, cause the at least one processor to receive one or more training corpora for training a machine learning model comprising a plurality of encoder blocks that each includes an attention layer and a feedforward network. The medium also contains instructions that, when executed by the at least one processor, cause the at least one processor to use the one or more training corpora to train an attention dictionary shared across the plurality of encoder blocks.

In a fourth embodiment, a method includes receiving an input at a mobile device that stores a trained machine learning model. The trained machine learning model includes a plurality of encoder blocks, an attention dictionary shared across the plurality of encoder blocks, an index matrix for each of the encoder blocks, and a coefficient matrix for each of the encoder blocks. The method also includes performing a linear projection of the input in each of the plurality of encoder blocks using the attention dictionary, the index matrix associated with the respective encoder block, and the coefficient matrix associated with the respective encoder block.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(1) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIGS. 2A and 2B illustrate an example transformer and an example counterpart dictionary transformer in accordance with this disclosure;

FIGS. 3A and 3B illustrate additional details of an example transformer and an example counterpart dictionary transformer in accordance with this disclosure;

FIG. 4 illustrates a first example portion of a dictionary transformer in accordance with this disclosure;

FIG. 5 illustrates a second example portion of a dictionary transformer in accordance with this disclosure;

FIG. 6 illustrates an example training of a dictionary transformer in accordance with this disclosure;

FIG. 7 illustrates an example system involved with a dictionary transformer during a training phase in accordance with this disclosure;

FIG. 8 illustrates an example system involved with a dictionary transformer during an inference phase in accordance with this disclosure;

FIG. 9 illustrates an example method for training a machine learning model in accordance with this disclosure; and

FIG. 10 illustrates an example method for using a trained machine learning model in accordance with this disclosure.

### DETAILED DESCRIPTION

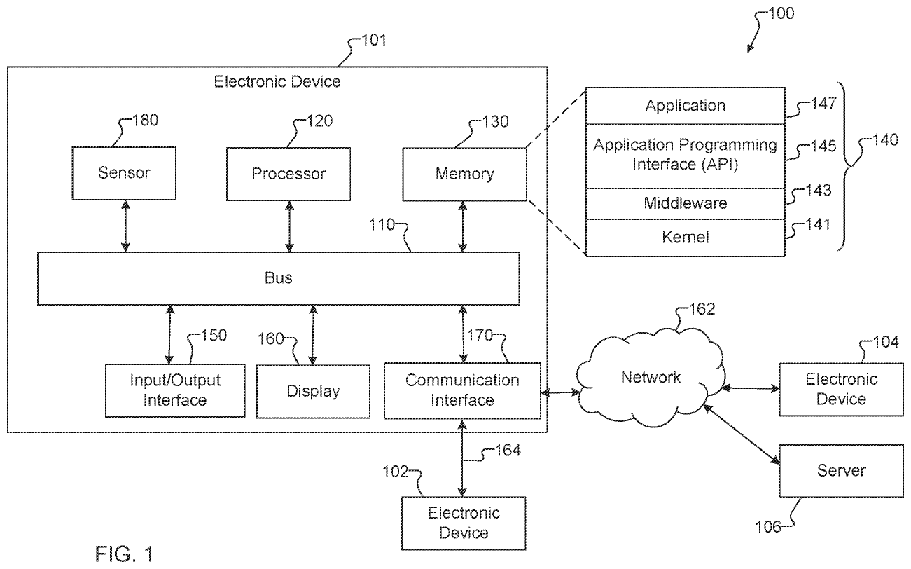

FIGS. 1 through 10, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, machine learning-based technologies are being used more and more often in many different applications, such as imaging, natural language processing (NLP), computer vision (CV), beam steering, and the like. Many mobile electronic devices, such as smartphones and tablet computers, include or utilize machine learning models or other technologies that have been developed to provide such features. However, one challenge involves model size. A transformer with increasing model size often results in improved performance, but the increasing model size is not realistic in many applications due to hardware memory limitations and long inference/training times. Also, analysis has found that existing transformers are usually over-parameterized. An over-parameterized transformer is usually inevitable in certain machine learning models.

Transformers have been widely used in various tasks for their superior capability in capturing long-distance dependencies. However, this performance is achieved using very large model sizes. For example, a Text-to-Text Transfer Transformer with a hidden dimension of 65K and the 3^{rd} Generation Pre-trained Transformer (GPT-3) with 96 transformer blocks have 11 billion and 175 billion parameters, respectively. These large transformers suffer from various issues, such as complicated learning and difficult deployment on resource-constrained devices like mobile devices and Internet of Things (IoT) devices. As a particular example, during the training of a large transformer model, large training corpora or careful regularization are often required. As another particular example, the trained model may be over-parameterized. In addition, the large model sizes are beyond the capabilities of many edge devices including mobile devices and IoT devices. These types of models may be impossible to deploy on certain devices or, if deployed, can have significant impacts on the performance of the devices.

This disclosure provides an efficient shared dictionary that can be used to provide a compact, fast, and accurate transformer model. This dictionary significantly reduces redundancy in the transformer's parameters by replacing the transformer's parameters with a compact shared dictionary, which can help to achieve fewer unshared coefficients and indices. Also, the dictionary enables faster computations since expensive weight multiplications are converted into computationally-cheap shared look-ups in the dictionary and fewer linear projections.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described below, the processor 120 may be used to generate a compact, fast, and accurate transformer model, such as during a training process. The processor 120 may also or alternatively use a compact, fast, and accurate transformer model, such as during an inference process.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 includes one or more applications for generating or using a compact, fast, and accurate transformer model. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The electronic device 101 further includes one or more sensors 180 that can meter a physical quantity or detect an activation state of the electronic device 101 and convert metered or detected information into an electrical signal. For example, one or more sensors 180 may include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The wireless communication is able to use at least one of, for example, long term evolution (LTE), long term evolution-advanced (LTE-A), 5th Generation (5G) wireless system, millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 includes at least one communication network, such as a computer network (like a local area network (LAN) or wide area network (WAN)), Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may be used to generate a compact, fast, and accurate transformer model, such as during a training process. The server 106 may also or alternatively use a compact, fast, and accurate transformer model, such as during an inference process.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

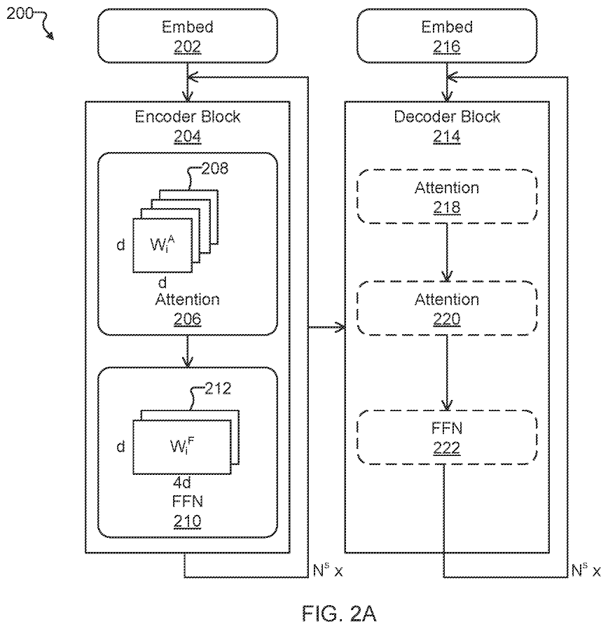

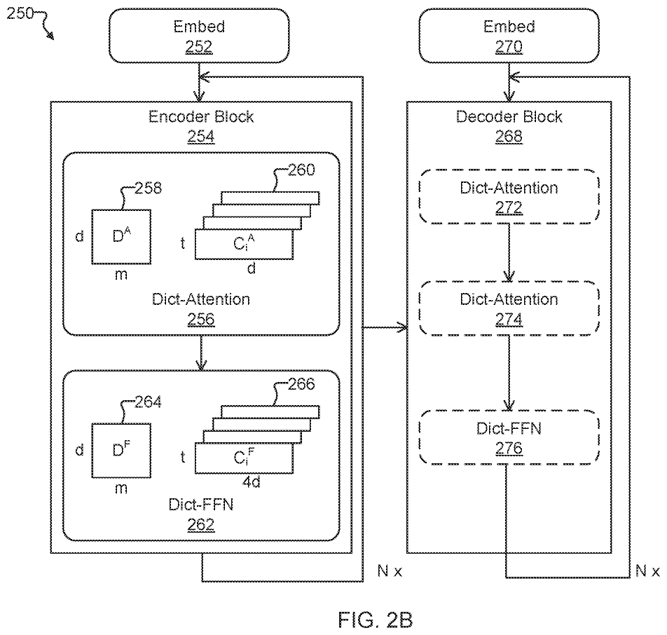

FIGS. 2A and 2B illustrate an example transformer 200 and an example counterpart dictionary transformer (“DictFormer”) 250 in accordance with this disclosure. For ease of explanation, the transformer 200 and the dictionary transformer 250 shown in FIGS. 2A and 2B are described as being implemented on or supported by one or more components in the network configuration 100 of FIG. 1, such as the electronic device 101, the server 106, or both. However, the transformer 200 and the dictionary transformer 250 shown in FIGS. 2A and 2B could be used with any other suitable device(s) and in any other suitable system(s).

As shown in FIG. 2A, the transformer 200 supports weight sharing. A transformer with weight sharing may contain three parts, namely an embedding layer, N^{s} encoder blocks, and N^{s} decoder blocks. Each encoder/decoder block can contain attention and feedforward network (FFN) units. The embedding size is d^{s}, and the FFN feature size is 4×d^{s}. Weights in the i^{th} attention unit and FFN can be respectively denoted as Wᵢ^{A} and Wᵢ^{F}. To match or improve the accuracy of a transformer without weight sharing, a transformer with weight sharing can be wider (d^{s}>d) or deeper (N^{s}>N), where d and N are the embedding size and blocks number of transformer without weight sharing. However, a wider transformer can be associated with a large model size and a large number of multiply-add operations (mult-adds), and a deeper transformer can be associated with a large number of mult-adds.

In FIG. 2A, the transformer 200 includes a word embedding unit 202 that provides a representation of one or more words to be employed in analysis to an encoder block 204. The encoder block 204 includes an attention unit 206 that can mimic cognitive attention to focus on important portions of the input. The attention unit 206 uses a plurality of weights Wᵢ^{A} 208 having dimension d×d, and the attention unit 206 includes N layers. Outputs of the attention unit 206 are provided to a feed forward network (FFN) 210, which uses a plurality of weights Wᵢ^{F} 212 having dimension d×4d. The weights Wᵢ^{A} 208 and the weights Wᵢ^{F} 212 are not shared here. For both weights Wᵢ^{A} 208 and weights Wᵢ^{F} 212, i∈[0, N−1]. The encoder block 204 provides inputs to a decoder block 214, which also receives a representation of one or more words to be employed in analysis from a word embedding unit 216. The decoder block 214 includes N layers, as well as a series of attention units 218-220 and an FFN 222. The number of parameters for the transformer 200 is 0(d2N), and the number of mult-adds is 0(d2Nn).

Weight sharing can be effective to compress a model's size for models based on transformer encoders. In some cases, sharing all parameters across layers may not introduce accuracy reductions. However, in other cases (such as for generative sequence-to-sequence models based on transformer encoders and decoders), sharing all parameters across layers can significantly decrease accuracy when performing model-based tasks. To match a standard transformer's accuracy, weights may be shared only across partial layers instead of all layers. Unfortunately, partial weight sharing remarkably brings down the model size compression effects of weight sharing. Also, determining which layers should be shared in partial weight sharing can be difficult due to the large and dynamic search space that is dependent on the specific machine learning tasks.

A universal transformer, which is based on sharing all parameters, may match or improve performance at the cost of a wider or deeper transformer architecture of the type shown in FIG. 2A. A wider transformer with a larger embedding dimension can enlarge the model size and bring larger computations (mult-adds). A deeper transformer with more encoder/decoder blocks may not increase model size but can introduce more computations. Moreover, weight sharing techniques cannot reduce mult-adds numbers and training/inference times. Therefore, weight sharing techniques cannot help the deployment of transformers on resource-limited devices and obtain real-time machine learning applications.

To help address these or other problems, this disclosure describes embodiments of a dictionary transformer, which supports dictionary sharing instead of weight sharing. In particular, the dictionary transformer can share a dictionary across all layers so that there is no need to decide which layers should be shared. Also, the dictionary transformer may not require a wider embedding size or more encoder/decoder blocks to improve accuracy, since the dictionary transformer can be dependent on a few unshared look-up coefficients. The dictionary transformer can compress model size by parameter sharing and enable computation sharing to reduce running latency. As a result, the dictionary transformer provides a compact, fast, and accurate transformer model for sequence-to-sequence tasks or other machine learning tasks.

In some embodiments, the dictionary transformer of this disclosure can convert each weight tensor in a conventional transformer into a shared dictionary and unshared coefficients. In the dictionary transformer with dictionary sharing, the i^{th} transformer block weights Wᵢ^{A} 208 and weights Wᵢ^{F} 212 can be represented by smaller dictionaries D^{A} and D^{F} and coefficients Cᵢ^{A} and Cᵢ^{F}, where the dictionary size m<d and the coefficient size t<<d.

As shown in FIG. 2B, the dictionary transformer 250 in accordance with this disclosure includes a word embedding unit 252 that provides a representation of one or more words to be employed in analysis to an encoder block 254. The encoder block 254 includes an attention unit (“Dict-Attention”) 256 that uses a dictionary D^{A} 258 having dimension d×m, together with coefficients Cᵢ^{A} 260 (where i∈[0, N−1]) having dimension t×d. The attention unit 256 includes N layers. Outputs of the attention unit 256 are provided to a feed forward network (“Dict-FFN”) 262, which uses a dictionary D^{F} 264 having dimension d×m, together with coefficients Cᵢ^{F} 266 (where i∈[0, N−1]) having dimension t×4d. The dictionary D^{A} 258 and the dictionary D^{F} 264 are shared by N blocks. The encoder block 254 provides inputs to a decoder block 268, which also receives a representation of one or more words to be employed in analysis from a word embedding unit 270. The decoder block 268 also includes N layers, as well as a series of attention units (“Dict-Attention”) 272-274 and an FFN (“Dict-FFN”) 276. The number of parameters for the dictionary transformer 250 is 0(d(m+tN)), and the number of mult-adds is 0(dNn(m+t)).

The dictionary transformer 250 with dictionary sharing provides a fast, compact, and accurate transformer. While matching the accuracy of the transformer 200 (which uses N layers without sharing and large attention and FFN weights Wᵢ^{A} 208 and Wᵢ^{F} 212), the dictionary transformer 250 can reduce the number of model parameters significantly and the number of mult-adds. In some cases, both can be reduced by a factor of three or more. This can be achieved using smaller one-layer shared dictionaries D^{A} 258 and D^{F} 264 and N-layer coefficients Cᵢ^{A} 260 and Cᵢ^{F} 266. The mult-add operations between weights and inputs in the transformer 200 can be replaced by dictionary look-ups and few linear predictions with coefficients in the dictionary transformer 250.

Although FIGS. 2A and 2B illustrate one example of a transformer 200 and one example of a counterpart dictionary transformer 250, various changes may be made to FIGS. 2A and 2B. For example, the transformer 200 and the dictionary transformer 250 may have any suitable number of each illustrated component in any suitable arrangement.

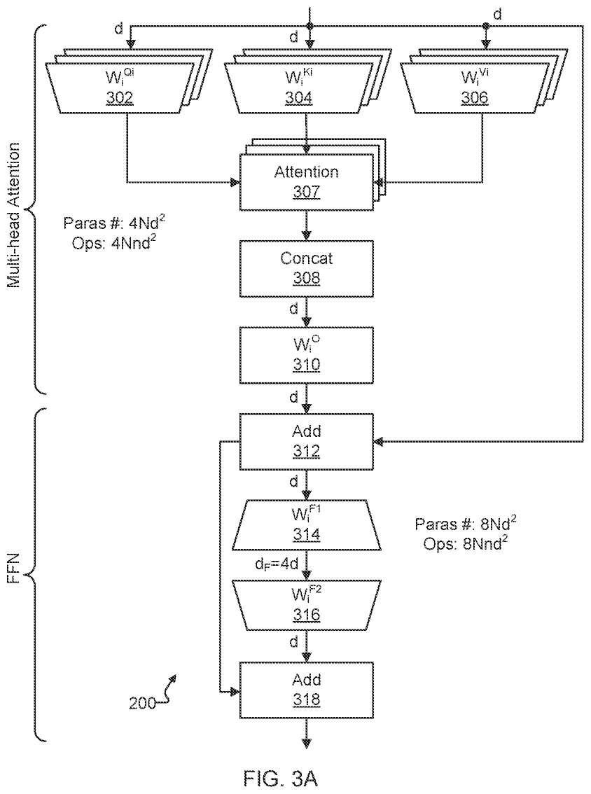

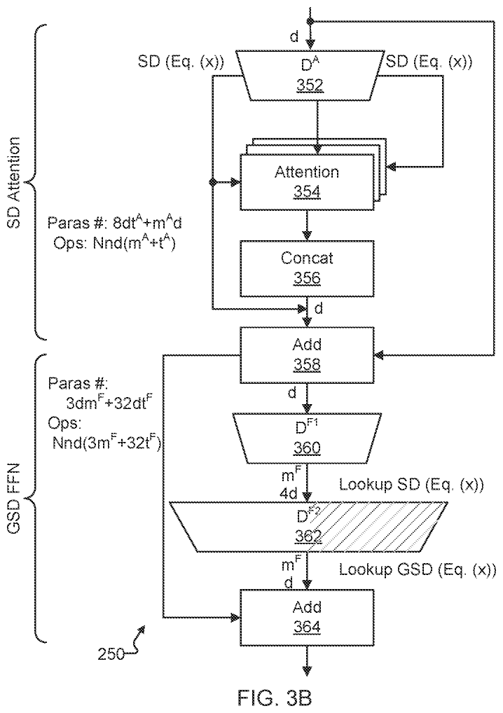

FIGS. 3A and 3B illustrate additional details of the example transformer 200 and the example counterpart dictionary transformer 250 in accordance with this disclosure. As shown in FIG. 3A, the transformer 200 in this example is associated with four weights, namely a query weight Wᵢ^{Q}^{ᵢ}, a key weight Wᵢ^{K}^{ᵢ}, a value weight Wᵢ^{V}^{ᵢ}, and an output weight Wᵢ^{O}^{ᵢ}. The transformer 200 may therefore have 4 Nd² parameters and perform 4 Nnd² mult-adds given a sequence size n. As shown here, the weights Wᵢ^{F} used by the FFN have two parts, namely Wᵢ^{F}^{₁} and Wᵢ^{F}^{₂}. The N-layer FFN blocks may therefore have 8 Nd² parameters and perform 8 Nnd² mult-adds operations.

Given an N-layer transformer model, variables Qᵢ, Kᵢ, and Vᵢ can be defined respectively as the i^{th} query, key, and values. Here, attention scores may be calculated by a scaled dot-product operation, such as the one shown in Equation (1), where

$$\frac{1}{\sqrt{d}}$$

is a scaling factor.

$$Attention ( {Q}_{i} , {K}_{i} , {V}_{i} ) = softmax ( \frac{{Q}_{i} \cdot {K}_{i}^{T}}{\sqrt{d}} ) \cdot {V}_{i} . \qquad ( 1 )$$

Accordingly, the transformer 200 includes arrays of multiplexers 302, 304, 306 that apply weights Wᵢ^{Q}^{ᵢ}, Wᵢ^{K}^{ᵢ}, and Wᵢ^{V}^{ᵢ}, respectively. Each of the multiplexers 302, 304, 306 receives d-dimension inputs. Outputs of the multiplexers 302, 304, and 306 are received by one or more attention units 307, and outputs of the attention unit(s) 307 are received by a concatenation unit 308. Instead of performing a single attention function with a d-dimension query, a d-dimension key, and a d-dimension value, a multi-head attention may be used with

$$a \frac{a}{h} - dimension h - head$$

query,

$$a \frac{d}{h} - dimension h - head key , and a \frac{d}{h} - dimension h - head value .$$

A d-dimension output from the concatenation unit 308, weighted by a weight Wᵢ^{O} 310, forms the output of a multi-head attention layer formed by the components described. In some cases, the multi-head attention layer determines multi-head values using Multihead(Qᵢ, Kᵢ, Vᵢ)=MHᵢ·Wᵢ^{O}, where MHᵢ may be defined as follows.

MHᵢ=Concat(headᵢ¹, . . . , headᵢ^{h}) (2)

Here, the attention value headᵢ^{j} for each head j of layer i can be expressed as headᵢ^{j}=(Qᵢ·Wᵢ^{Q}^{ᵢ}, Kᵢ·Wᵢ^{K}^{ᵢ}, Vᵢ·Wᵢ^{V}^{ᵢ}). Within multi-head attention, the number of parameters is 4 Nd², and the number of (mult-add) operations is 4 Nnd².

The weighted output of the multi-head attention layer is received by an add unit 312 in the FFN, which adds the weighted output and the original input. The output of the add unit 312 is demultiplexed by a demultiplexer 314, which applies weights Wᵢ^{F}^{₁} and outputs d_{F}=4d values. The outputs of the demultiplexer 314 are received by a multiplexer 316, which applies weights Wᵢ^{F}^{₂} and outputs d-dimension values to an add unit 318. The add unit 318 adds the outputs from the add unit 312 and the multiplexer 316 to produce the output of the FFN. Within the FFN, the number of parameters is 8 Nd², and the number of (mult-add) operations is 8 Nnd².

In contrast, the dictionary transformer 250 significantly reduces the number of parameters and the number of mult-adds relative to the transformer 200. As shown in FIG. 3B, each block of the dictionary transformer 250 replaces the attention and FFE with shared dictionary (SD) attention and group-wise shared dictionary (GSD) FFN. Linear projection can be performed by looking up dictionary D^{A}, such as by using Equation (7) below. In some cases, SD attention may include 8 dt^{A}30 m^{A}d parameters and perform Nnd(m^{A}+t^{A}) operations, and GSD FFN may include 3 dm^{F}+32 dt^{F} parameters and perform Nnd(3 m^{F}+32 t^{F}) operations, where t and m are the sizes of the coefficient and dictionary, respectively.

The dictionary transformer 250 here includes a single input multiplexer 352 that receives d-dimension inputs and uses a shared attention dictionary D^{A}. The shared attention dictionary D^{A}, indices Iᵢ, and coefficients Cᵢ replace weights Wᵢ^{Q}^{ᵢ}, Wᵢ^{K}^{ᵢ}, Wᵢ^{V}^{ᵢ}, and Wᵢ^{O}^{ᵢ}. in the transformer 200. The attention dictionary D^{A}, indices Iᵢ, and coefficients Cᵢ may have sizes d×m^{A}, t^{A}×d, and t^{A}×d, respectively. Also, linear projections in the transformer attention 306 (such as Wᵢ^{Q}^{ⱼ}·Qⱼ) are replaced by a light-weight shared dictionary projection function (such as SD(Qᵢ, D^{A}, Cᵢ^{Q}^{ⱼ}, Iᵢ^{Q}^{ⱼ})) 354, which may be derived as shown below in Equation (7). In this example, SD(Qᵢ, D^{A}, Cᵢ^{Qis j}, Iᵢ^{Q}^{ⱼ}) can be used to replace Wᵢ^{Q}^{ⱼ}·Qⱼ because Wᵢ^{Q}^{ⱼ} can be reconstructed by looking up D^{A} and performing a few linear projections with coefficients Cᵢ^{Q}^{ⱼ} and indices Iᵢ^{Q}^{ⱼ}. A concatenation unit 356 can derive MHᵢ, such as by using Equation (2) above.

The concatenated output of the multi-head attention layer is received by an add unit 358 in the FFN, which adds the output and the original input for d output values. An output of the add unit 358 is input to a dictionary D^{F}^{₁} 360, which outputs 4 d values passed to the dictionary D^{F}^{₂} 362. In some cases, the dictionary D^{F}^{₂} 362 contains G groups as discussed below and outputs d values. Outputs of the dictionary D^{F}^{₁} 360 are added to outputs of the add unit 358 by an add unit 364 to form the output of the GSD FPN in the dictionary transformer 250.

In some embodiments, the dictionary transformer 250 utilizes the following multi-head equation.

MultiHead(Qᵢ,Kᵢ,Vᵢ)=SD(MHᵢ,D^{A},Cᵢ^{O},Iᵢ^{O}) (3)

Here, MHᵢ can be derived according to Equation (2) above. The attention value headᵢ^{j} for each head j of layer i may be determined as follows.)

headᵢ^{j}=Attention(SD(Qᵢ,D^{A}, Cᵢ^{Q}^{ⱼ},Iᵢ^{Q}^{ⱼ}), SD(Kᵢ,D^{A},Cᵢ^{K}^{ⱼ},Iᵢ^{K}^{ⱼ}), SD(Vᵢ,D^{A},Cᵢ^{V}^{ⱼ},Iₜ^{V}^{ⱼ})) (4)

In some cases, the light-weight shared dictionary projection function may be expressed as follows.

$$\begin{matrix}SD ( {Q}_{i} , {D}^{A} , {C}_{i}^{{Q}_{j}} , {I}_{i}^{{Q}_{j}} ) = {Q}_{i} \cdot {\sum }_{t = 1}^{{t}^{A}} {C}_{i}^{{Q}_{j}} [ t , {i}_{d} ] ⊙ {D}^{A} [ : , {I}_{i}^{{Q}_{j}} [ t , {i}_{d} ] ] \\ = ( {\sum }_{t = 1}^{{t}^{A}} {Q}_{i} \cdot {D}^{A} [ : , {J}_{i}^{{Q}_{j}} [ t , {i}_{d} ] ] ) ⊙ {C}_{i}^{{Q}_{j}} [ t , {i}_{d} ] \\ = {\sum }_{t = 1}^{{t}^{A}} {O}_{i} [ : , {I}_{i}^{{Q}_{j}} [ t , {i}_{d} ] ] ⊙ {C}_{i}^{{Q}_{j}} [ t , {i}_{d} ] , {i}_{d} ∈ [ 0 , \frac{d}{h} ]\end{matrix} \qquad ( 5 )$$

$${O}_{i} [ : , b ] = {Q}_{i} \cdot {D}^{A} [ : , b ] , b ∈ [ 1 , m ] \qquad ( 6 )$$

In Equation (5), the lookup of D^{A} by indices Iᵢ^{Q}^{ⱼ} is defined by D^{A} [:,Iᵢ^{Q}^{ⱼ}[t,i_{d}]], which can fetch the Iᵢ^{Q}^{ⱼ}[t,i_{d}]-column vector from D^{A}. Unshared linear projection used to enlarge the representation ability of the shared dictionary is depicted by [symbol] =Σₜ₌₁^{t}^{^{A}}Cᵢ^{Q}^{ⱼ}[t,i_{d}]⊙ D^{A} [:,Iᵢ^{Q}^{ⱼ}[t,i_{d}]], where the operator ⊙ represents scaling a fetched vector from a dictionary with a scalar in coefficients. As a result, Wᵢ^{Q}^{ⱼ}·Qⱼ can be constructed by [symbol] ·Qⱼ in Equation (5) since [symbol] ≈Wᵢ^{Q}^{ⱼ}. Directly reconstructing [symbol] and multiplying it with Qⱼ potentially increases the number of computations. To address this issue, a shared dictionary function to reuse computations in Equation (5) is proposed by computing the multiplications between Qⱼ and the dictionary D^{A} (where the result is Oᵢ as defined by Equation (6)) and looking up Oᵢ instead of D^{A} using Iᵢ^{Q}^{ⱼ} and Cᵢ^{Q}^{ⱼ}.

Although FIGS. 3A and 3B illustrate additional details of the example transformer 200 and the example counterpart dictionary transformer 250, various changes may be made to FIGS. 3A and 3B. For example, the transformer 200 and the dictionary transformer 250 may have any suitable number of each illustrated component in any suitable arrangement.

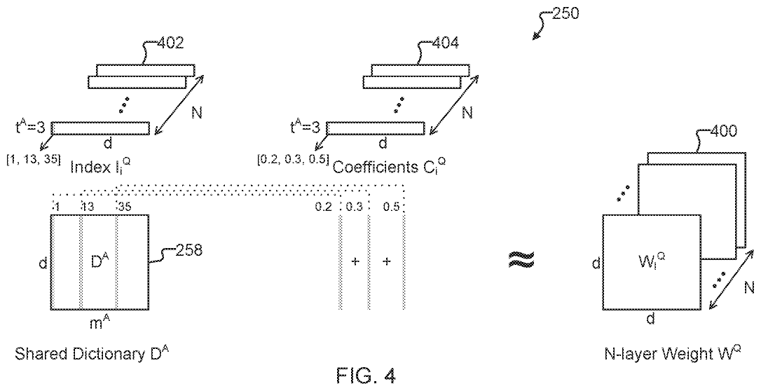

FIG. 4 illustrates a first example portion of a dictionary transformer 250 in accordance with this disclosure. For simplicity and clarity, only the first portion of the dictionary transformer 250 is shown in FIG. 4. Specifically, the shared dictionary (SD) D^{A} 258 and a data structure 404 for N-layer coefficients Cᵢ^{A} 260 are depicted. FIG. 4 here illustrates an example of replacing N-layer weights W^{Q}, W^{K}, W^{V}, and W^{O} with shared dictionary D^{A}, index Iᵢ^{Q}, and coefficients Cᵢ^{Q} having a size t^{A}=3. While only weight W^{Q} is depicted in FIG. 4, it will be understood that the same process may be employed for weights W^{K}, W^{V}, and W^{O}.

As shown in FIG. 4, Equation (5) can be used to reconstruct an N-layer weight W^{Q} from a shared dictionary D^{A} with index Iᵢ^{Q} and coefficients Cᵢ^{Q}. In the embodiment of FIG. 4, to construct the first column of weight Wᵢ^{Q} given the shared dictionary D^{A} 258, the first column of index matrix Iᵢ^{Q} is taken out (such as [1, 13, 35]) and is used as the indices to fetch the corresponding columns from D^{A} (such as D^{A}[:][1], D^{A}[:][13], D^{A}[:][35]). The first column of coefficients Cᵢ^{Q} (such as [0.2,0.3,0.50) is multiplied by the corresponding dictionary columns (D^{A}[:][1], D^{A}[:][13], D^{A}[:][35], respectively), and the sum of the multiplication results works as the first column of Wᵢ^{Q}. In this way, weights W in the attention unit 206 with 4 d²N parameters are compressed into m^{A}, I^{Q}, and C^{Q} with size dm^{A}+8 t^{A}d. Using Equation (5), the computations can also be reduced.

In the dictionary transformer 250, a new architecture with the shared dictionary D^{A} 258, indices Iᵢ^{Q} 302, and coefficients Cᵢ^{Q} 304 replaces the previous weights W^{Q} 400 in the transformer 200. The shared dictionary D^{A} 258, indices Iᵢ^{Q} 402, and coefficients Cᵢ^{Q} 404 are determined differently from the weights W^{Q} 300, so the total model size of the dictionary transformer 250 is smaller than that of the transformer 200. Moreover, in the dictionary transformer 250, the dictionary D^{A} 258 is shared across N layers, while the indices Iᵢ^{Q} 402 and coefficients Cᵢ^{Q} 404 are not. This makes the dictionary transformer 250 compact, and sharing the dictionary D^{A} 258 (but not the indices Iᵢ^{Q} 402 and coefficients Cᵢ^{Q} 404) makes the model more accurate.

The FFN in the transformer 200 includes two-layer computations, namely (i) F₁=max(0, Xᵢ·Wᵢ^{F}^{₁}+b₁) and (ii) F₂=F₁·Wᵢ^{F}^{₂}+b₂. Instead of the regular linear predictions Xᵢ·Wᵢ^{F}^{₁}+b₁ and F₁·Wᵢ^{F}^{₂}+b₂ in the FFN 210 of the transformer 200, the dictionary transformer 250 uses a light-weight GSD projection (given below) to compute the FFN, such as GSD(Xᵢ, D, Cᵢ^{F}^{₁}, Iᵢ^{F}^{₁}, G) and GSD(F₁, D, Cᵢ^{F}^{₂}, Iᵢ^{F}^{₂}, G). In SD projection, replacing N d×d weights with a d×m dictionary works well where each column of the dictionary is multiplied by a scalar. However, when the column of a dictionary is large (such as 4×d in the second FFN layer), SD projection may be difficult to obtain with high quality performance since a vector of the dictionary with 4×d elements (such as 2,048 elements when d=512) multiplied by the same scalar may not be sufficiently flexible.

To increase the flexibility of SD projection and improve performance, GSD divides each column of the dictionary into G groups (such as equally) and assigns a unique scalar to multiply the numbers in each group. In some embodiments, this can be expressed as follows.

F₁=max(0, GSD(Xᵢ,D,Cᵢ^{F}^{₁},Iᵢ^{F}^{₁},G)+b₁) (7)

F₂=GSD(F₁,D,Cᵢ^{F}^{₂},Iᵢ^{F}^{₂},G)+b₂ (8)

The computation of GSD may be performed as follows.

$$G S D ( {X}_{i} , {D}^{{F}_{2}} , {C}_{i}^{{F}_{2}} , {I}_{i}^{{F}_{2}} , G ) = {\sum }_{g = 1}^{G} {\sum }_{t = 1}^{t = {F}_{2}} {O}^{g} [ : , {I}_{i}^{{F}_{2}} [ t , {i}_{d} ] ] ⊙ {C}_{i}^{{F}_{2}^{g}} [ t , {i}_{d} ] \qquad ( 9 )$$

$${O}^{g} [ : , b ] = X [ : , {Index}_{g} ] \cdot {D}^{{F}_{2}} [ {Index}_{g} , b ] ,$$

$$g ∈ [ 1 , G ] , b ∈ [ 1 , {m}^{{F}_{2}} ] , {Index}_{g} = [ ( g - 1 ) \frac{4 d}{G} , g \frac{4 d}{G} ] \qquad ( 10 )$$

Here, the dictionary D^{F}^{₂}[:,:] is divided equally into G groups, and the g^{th} group is defined as D^{F}^{₂}[Index_{g},:], where

$${Index}_{g} = [ ( g - 1 ) \frac{4 d}{G} , g \frac{4 d}{G} ]$$

and g∈[1,G]. Also, the multiplication result between the g^{th} group dictionary and an input is defined as O^{g}[:,b] as shown in Equation (10), where b∈[1,m^{F}^{₂}]. Different groups of dictionaries can share the same lookup indices Iᵢ^{F}^{₂}. The t^{F}^{₂} queried vectors in each group can be scaled by the corresponding Cᵢ^{F}^{₂} and g coefficients, and the scale results can be accumulated to derive the g^{th} GSD result shown in Equation (9). In addition, G group-wise GSD results can be summed to determine the final GSD result.

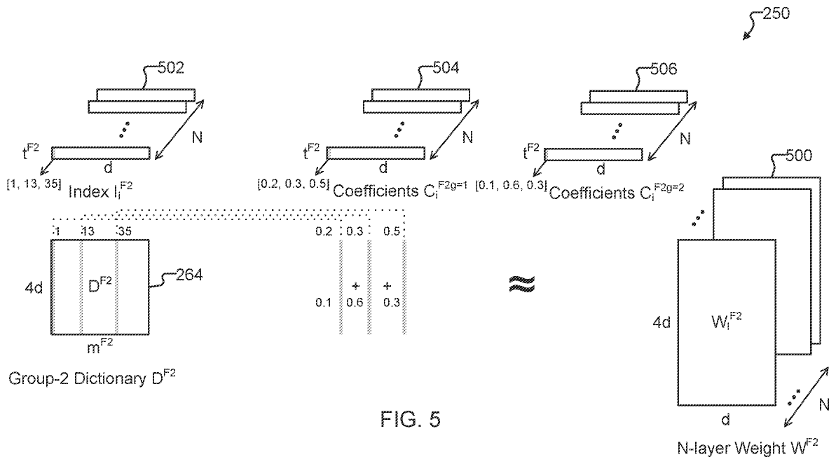

FIG. 5 illustrates a second example portion of a dictionary transformer 250 in accordance with this disclosure. For simplicity and clarity, only the second portion of the dictionary transformer 250 is shown in FIG. 5. Specifically, a portion of the dictionary D^{F} 264 and data structures 504, 506 for coefficients Cᵢ^{F} 266 are depicted. FIG. 5 here illustrates an example of a GSD for large-dimension models or layers, such as the FFN, and specifically an example of a group-2 shared dictionary for the second layer of the FFN 262 in the dictionary transformer 250 (which replaces an N-layer weight Wᵢ^{F}^{₂} 500). The dictionary D^{F2} 264 is equally split into two parts that share the same indices Iᵢ^{F}^{₂} 502, but each group has unique coefficients (such as [symbol] 504 and [symbol] 506). The first group and the second group use corresponding coefficients (such as [0.2,0.3,0.5] and [0.1,0.6,0.3]) to scale the queried dictionary vectors, respectively. The accumulation of the scaled vectors can be used to represent W^{F}^{₂}.

Although FIGS. 4 and 5 illustrate example portions of a dictionary transformer 250, various changes may be made to FIGS. 4 and 5. For example, various components of the dictionary transformer 250 may be combined, further subdivided, replicated, or rearranged according to particular needs.

The dictionary transformer 250 here represents weights of the transformer 200 with linear projections of a dictionary, thereby having two-step computations: (i) small projections where the dictionary transformer 250 computes a small multiplication between the input and the dictionary 264 and generates an intermediate variable O and (ii) lookup and scale where the dictionary transformer 250 looks up O and scales the lookup result with coefficients. Accordingly, to train the dictionary transformer 250, the dictionary, the index I, and the coefficients C can be jointly optimized in some embodiments. Directly training the dictionary transformer 250 may lead to a combinatorial operation problem in some instances since index I is typically non-continuous. Although automated machine learning like AutoML could be used (such as an evolutionary method with reinforcement learning) to jointly learn the dictionary, the index I, and the coefficients C, these methods may have large training times with low performance In some embodiments, to work around the training of index I, the shared dictionary attention and FFN can be used to perform a regular linear projection with sparse constraints, which can efficiently train the dictionary transformer 250.

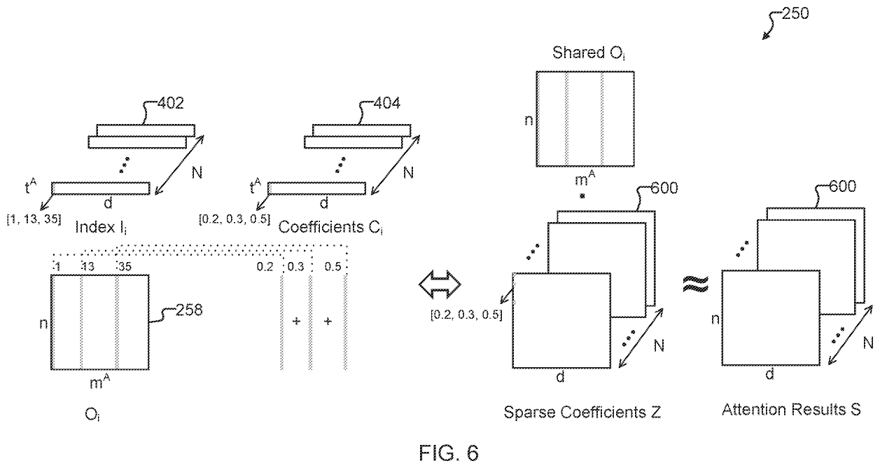

FIG. 6 illustrates an example training of a dictionary transformer 250 in accordance with this disclosure. The process here involves training sparse coefficients Z instead of jointly training the index I and the coefficients C. After training, the sparse coefficients Z can be converted to the index I and the coefficients C for deployment. As shown in FIG. 6, to train the dictionary transformer 250, the index Iᵢ and the coefficients Cᵢ are converted into sparse coefficients Z so that training of the index Iᵢ and coefficients Cᵢ is replaced with training of the sparse coefficients Z. During the deployment phase, the sparse coefficients Z can be reversely transformed into the index Iᵢ and coefficients Cᵢ as shown in FIG. 6. The shape of the coefficients C and index I may be t^{A}×d×N, and the shape of the sparse coefficients Z may be m^{A}×d×N.

In some embodiments, there may be two steps to deriving the sparse coefficients Z, namely (i) initializing all elements as zero and (ii) copying the coefficients C to the sparse coefficients Z according to index values in Iᵢ. For example, since the first column of Iᵢ and Cᵢ in the example of FIG. 6 are [1,13,35] and [0.2,0.3,0.5], respectively, all entries in the first column of the sparse coefficients Z 600 are zeros except the first entry, the thirteenth entry, and the thirty-fifth entry (which are 0.2, 0.3, and 0.5, respectively). Therefore, the lookup and scale of shared Oᵢ (which, together with the sparse coefficients Z 600, replaces the N-layer weight 500) to compute the attention or FFN results can be converted into the matrix multiplication between Oᵢ and Zᵢ shown in Equation (11), and the new coefficient C may have a sparsity constraint such that the non-zero elements (I₀ norm) of each column is t^{A}<<m^{A} as shown in Equation (12).

$${\sum }_{t = 1}^{{t}^{A}} {O}_{i} [ : , I [ t , {i}_{d} ] ] ⊙ {C}_{i}^{{Q}_{i}} [ t , {i}_{d} ] = {O}_{i} \cdot {Z}_{i}^{{Q}_{j}} \qquad ( 11 )$$

$${‖ {Z}_{i}^{{Q}_{j}} : [ : , {i}_{d} ] ‖}_{{I}_{0}} = {t}^{A} \qquad ( 12 )$$

Considering that the I₀ norm sparsity constraint in Equation (12) is non-differentiable, this constraint may be loosened to an I₁ norm constraint as shown in Equation (13) to the non-zero parameters, leading to more parameters near zero.

$${\sum }_{1 d}^{d} {‖ {Z}_{i}^{{Q}_{j}} : [ : , {i}_{d} ] ‖}_{{I}_{1}} = {‖ Z ‖}_{{I}_{1}} \qquad ( 13 )$$

$$\frac{δ ( L + λ {‖ Z ‖}_{{I}_{1}} )}{δ Z} = \frac{δ L}{δ Z} + sign ( Z ) \qquad ( 14 )$$

$$μ ( x ) = \{ \begin{matrix}x , & if \vert x \vert > value ( ρ ) \\ 0 & otherwise\end{matrix} . \qquad ( 15 )$$

Here, the gradient of coefficients can be calculated by Equation (14), where parameter λ is used to control the trade-off between loss

$$\frac{δ L}{δ Z}$$

and the I₁ norm sparsity constraint. To improve training performance, dynamic-sparsity Z can be supported by enabling different columns to have near-zero elements. For example, Equation (15) can be used to globally change the near-zero values to zero given a ratio ρ, where value (ρ) derives the value at ratio ρ in ascending order.

Using the dictionary transformer 250 described above, it is possible to significantly reduce the number of parameters in a transformer-based machine learning model while achieving the same or similar performance. For example, in some cases, the number of parameters may be reduced by a factor of twelve or more. In some embodiments using the dictionary transformer 250, all weights can be converted into shared dictionaries, lookup indices, and scaling coefficients. Also, using the dictionary transformer 250 described above, it is possible to significantly reduce the number of computational operations performed using a transformer-based machine learning model while achieving the same or similar performance For instance, in some cases, the number of computational operations may be reduced by a factor of four or more. In addition, the dictionary transformer 250 can achieve improved bilingual evaluation understudy (BLEU) scores compared to transformers having standard architectures.

Although FIG. 6 illustrates one example of the training of a dictionary transformer 250, various changes may be made to FIG. 6. For example, the dictionary transformer 250 may be trained in any other suitable manner

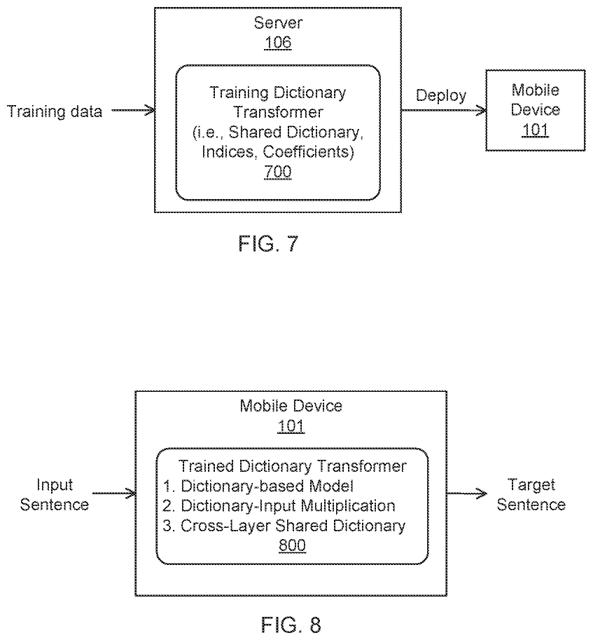

FIG. 7 illustrates an example system involved with a dictionary transformer 250 during a training phase in accordance with this disclosure, and FIG. 8 illustrates an example system involved with a dictionary transformer 250 during an inference phase in accordance with this disclosure. As shown in FIG. 7, during training, the server 106 receives training data and utilizes a training dictionary transformer 700, which includes shared dictionaries, indices, and coefficients, to generate a trained dictionary transformer that is deployed to an electronic device 101. As shown in FIG. 8, during inferencing, the electronic device 101 receives an input and employs a trained dictionary transformer 800 to generate a target sentence. The trained dictionary transformer 800 includes a dictionary-based model, dictionary-input multiplication, and a cross-layer shared dictionary.

Although FIGS. 7 and 8 illustrate example systems involved with a dictionary transformer 250 during a training phase and an inference phase, various changes may be made to FIGS. 7 and 8. For example, any other suitable device(s) may be used to perform training or inferencing. As a particular example, the same device may both train and use a dictionary transformer 250, or devices other than servers or mobile devices may be used to train or use a dictionary transformer 250.

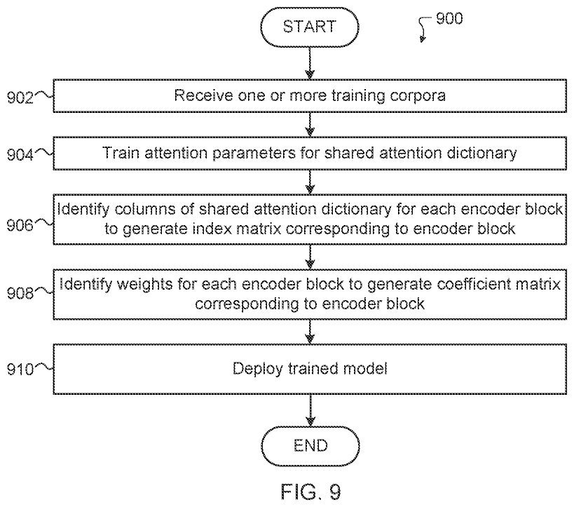

FIG. 9 illustrates an example method 900 for training a machine learning model in accordance with this disclosure. For ease of explanation, the method 900 shown in FIG. 9 is described as being performed using the server 106 in the network configuration 100 of FIG. 1. However, the method 900 shown in FIG. 9 could be performed using any other suitable device (such as the electronic device 101) and in any other suitable system.

As shown in FIG. 9, one or more training corpora are received at step 902. This may include, for example, the processor 120 of the server 106 obtaining training data for training a language translation model, an abstractive summarization model, a language model, or any other suitable machine learning model. The training data may be obtained from one or more sources. As particular examples, the training corpora may include training sequence pairs and/or a joint byte pair encoding (BPE) vocabulary, a dataset with corresponding multi- sentence summaries, or a language vocabulary.

Attention parameters for a shared attention dictionary to be shared across encoder blocks in the machine learning model at an attention layer are trained at step 904. This may include, for example, the processor 120 of the server 106 using the training corpora to derive attention parameters for each encoder block in the form of a weighted combination of columns from the shared attention dictionary. In some embodiments, training the attention parameters may include (i) determining an intermediate output matrix based on a product of a training example among the one or more training corpora and the shared attention dictionary, (ii) generating a sparse coefficient matrix for each encoder block from the index matrix and the coefficient matrix associated with the encoder block, and (iii) training the sparse coefficient matrix for each encoder block and the shared attention dictionary.

The columns of the shared attention dictionary for the weighted combination of columns for each encoder block are identified based on an index matrix for the respective encoder block at step 906. The weights for the weighted combination of columns for each encoder block are identified based on a coefficient matrix for the respective encoder block at step 908. After training, the trained machine learning model is deployed, such as to a mobile device like the electronic device 101, at step 910. In some embodiments, this may involve converting the trained sparse coefficient matrix for each encoder block into an index matrix and a coefficient matrix for the encoder blocks and deploying the single shared attention dictionary, the index matrices, and the coefficient matrices to the mobile device or other device(s).

Although FIG. 9 illustrates one example of a method 900 for training a machine learning model, various changes may be made to FIG. 9. For example, while shown as a series of steps, various steps in FIG. 9 may overlap, occur in parallel, occur in a different order, or occur any number of times.

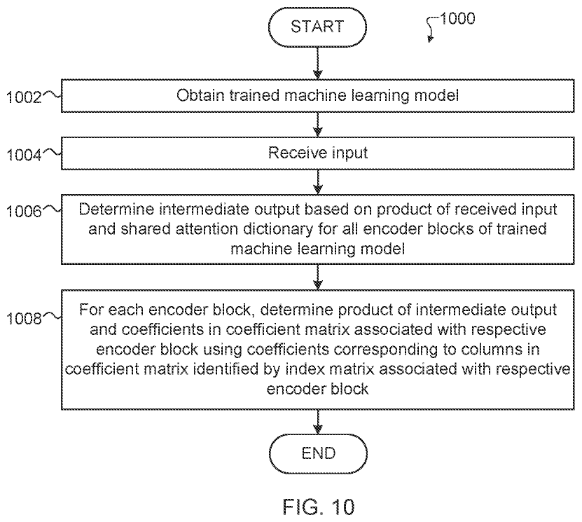

FIG. 10 illustrates an example method 1000 for using a trained machine learning model in accordance with this disclosure. For ease of explanation, the method 1000 shown in FIG. 10 is described as being performed using the electronic device 101 in the network configuration 100 of FIG. 1. However, the method 1000 shown in FIG. 10 could be performed using any other suitable device (such as the server 106) and in any other suitable system.

As shown in FIG. 10, a trained machine learning model is obtained at step 1002. This may include, for example, the processor 120 of the electronic device 101 obtaining a trained dictionary transformer 800 from the server 106. In some embodiments, the trained dictionary transformer 800 may be trained using the method 900 of FIG. 9 described above.

An input is received at step 1004. This may include, for example, the processor 120 of the electronic device 101 receiving a phrase to be translated from one language to another or other input to be processed. The received input is provided to the trained machine learning model for determination of an intermediate output at step 706. The intermediate output may be based on a product of the received input and a shared attention dictionary shared across all encoder blocks of the trained dictionary transformer 800. The trained dictionary transformer 800 includes the shared attention dictionary common to all encoder blocks, as well as an index matrix and a coefficient matrix both associated with each encoder block. That is, the index and coefficient matrices are not shared across the encoder blocks and can be distinct for each encoder block (even if, by happenstance, pairs of index and coefficient matrices for different encoder blocks are identical). Each encoder block within the trained dictionary transformer 800 determines a product of the intermediate with coefficients in the coefficient matrix associated with the respective encoder block at step 1008. The coefficients used in step 1008 correspond to columns in the coefficient matrix that are identified by indices within the index matrix associated with the respective encoder block.

Although FIG. 10 illustrates one example of a method 1000 for using a trained machine learning model, various changes may be made to FIG. 10. For example, while shown as a series of steps, various steps in FIG. 10 may overlap, occur in parallel, occur in a different order, or occur any number of times.

This disclosure has described new compact, fast, and accurate transformer architectures in the form of dictionary transformers. These architectures can be easily trained and deployed, such as to resource-constrained mobile and edge devices. The dictionary transformer uses dictionary sharing and unshared linear projection coefficients (instead of weight sharing). A shared dictionary can be shared among all encoder/decoder blocks and can significantly reduce parameter redundancy, thereby compressing the model size. Unshared linear projection coefficients can enable each encoder/decoder block to have distinct feature representations, thus improving the representation abilities compared to prior weight sharing. The dictionary transformer also supports dynamic control of the representation abilities of each encoder/decoder block by using the group-wise shared dictionary. For example, FFN in the dictionary transformer can benefit from the group-wise dictionary. It has much larger dimensions (such as 2,048) than the attention dimension, so a multi-group dictionary can be used to enlarge the representation. In addition, in some cases, the parameters of the dictionaries and coefficients in the dictionary transformer 250 can be learned automatically during the training phase.

Embodiments of this disclosure can reduce a transformer's model size, such as by reducing or eliminating redundant parameters. This can be particularly useful when deploying transformers on mobile/IoT devices or other devices. The dictionary transformer described here is based on the use of an efficient shared dictionary to provide a compact, fast, and accurate transformer model. Embodiments of the dictionary transformer can significantly reduce redundancy compared to a standard transformer's global parameters by replacing the standard transformer's parameters with a compact dictionary shared by all blocks and block-wise coefficients. Embodiments of the dictionary transformer can enable faster training and inferencing since attention and fully-connected blocks can be encoded as a few look-ups on a dictionary and linear projections. Compared to existing transformers, embodiments of the dictionary transformer consistently improve the performance of various tasks, such as machine translation, abstractive summarization, and language modeling.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving one or more training corpora for training a machine learning model comprising a plurality of encoder blocks, each encoder block including an attention layer and a feedforward network; and
using the one or more training corpora to train an attention dictionary shared across the plurality of encoder blocks.

2. The method of claim 1, wherein:
training the attention dictionary comprises training attention parameters of the attention layer in each of the plurality of encoder blocks; and
the attention parameters for a given encoder block among the plurality of encoder blocks are a weighted combination of columns from the attention dictionary shared across the plurality of encoder blocks.

3. The method of claim 2, further comprising:
identifying the columns for the weighted combination using an index matrix associated with the given encoder block; and
identifying weights for the weighted combination using a coefficient matrix associated with the given encoder block.

4. The method of claim 3, wherein the index matrix associated with the given encoder block and the coefficient matrix associated with the given encoder block are not shared across the plurality of encoder blocks.

5. The method of claim 3, wherein training the attention parameters comprises:
determining an intermediate output matrix based on a product of a training example among the one or more training corpora and the attention dictionary;
generating a sparse coefficient matrix for each encoder block using the index matrix and the coefficient matrix associated with the encoder block; and
training the sparse coefficient matrix for each encoder block and the attention dictionary.

6. The method of claim 5, further comprising:
deploying a trained machine learning model to a mobile device by:
converting the trained sparse coefficient matrix for each encoder block into an index matrix and a coefficient matrix for the encoder blocks; and
deploying the attention dictionary, the index matrices, and the coefficient matrices to the mobile device.

7. The method of claim 6, wherein the trained machine learning model comprises the attention dictionary, the index matrix for each of the plurality of encoder blocks, and the coefficient matrix for each of the plurality of encoder blocks.

8. An apparatus comprising:
at least one processing device configured to:
receive one or more training corpora for training a machine learning model comprising a plurality of encoder blocks, each encoder block including an attention layer and a feedforward network; and
use the one or more training corpora to train an attention dictionary shared across the plurality of encoder blocks.

9. The apparatus of claim 8, wherein:
to train the shared attention dictionary, the at least one processing device is configured to train attention parameters of the attention layer in each of the plurality of encoder blocks; and
the attention parameters for a given encoder block among the plurality of encoder blocks are a weighted combination of columns from the attention dictionary shared across the plurality of encoder blocks.

10. The apparatus of claim 9, wherein the at least one processing device is further configured to:
identify the columns for the weighted combination using an index matrix associated with the given encoder block; and
identify weights for the weighted combination using a coefficient matrix associated with the given encoder block.

11. The apparatus of claim 10, wherein the index matrix associated with the given encoder block and the coefficient matrix associated with the given encoder block are not shared across the plurality of encoder blocks.

12. The apparatus of claim 10, wherein, to train the attention parameters, the at least one processing device is configured to:
determine an intermediate output matrix based on a product of a training example among the one or more training corpora and the attention dictionary;
generate a sparse coefficient matrix for each encoder block using the index matrix and the coefficient matrix associated with the encoder block; and
train the sparse coefficient matrix for each encoder block and the attention dictionary.

13. The apparatus of claim 12, wherein:
the at least one processing device is further configured to deploy a trained machine learning model; and
to deploy the trained machine learning model, the at least one processing device is configured to:
convert the trained sparse coefficient matrix for each encoder block into an index matrix and a coefficient matrix for the encoder blocks; and
deploy the attention dictionary, the index matrices, and the coefficient matrices to the mobile device.

14. The apparatus of claim 13, wherein the trained machine learning model comprises the attention dictionary, the index matrix for each of the plurality of encoder blocks, and the coefficient matrix for each of the plurality of encoder blocks.

15. A non-transitory computer readable medium containing instructions that, when executed by at least one processor, cause the at least one processor to:
receive one or more training corpora for training a machine learning model comprising a plurality of encoder blocks, each encoder block including an attention layer and a feedforward network; and
use the one or more training corpora to train an attention dictionary shared across the plurality of encoder blocks.

16. The non-transitory computer readable medium of claim 15, wherein:
the instructions that when executed cause the at least one processor to train the shared attention dictionary comprise instructions that when executed cause the at least one processor to train attention parameters of the attention layer in each of the plurality of encoder blocks; and
the attention parameters for a given encoder block among the plurality of encoder blocks are a weighted combination of columns from the attention dictionary shared across the plurality of encoder blocks.

17. The non-transitory computer readable medium of claim 16, further containing instructions that when executed cause the at least one processor to:
identify the columns for the weighted combination using an index matrix associated with the given encoder block; and
identify weights for the weighted combination using a coefficient matrix associated with the given encoder block.

18. The non-transitory computer readable medium of claim 17, wherein the index matrix associated with the given encoder block and the coefficient matrix associated with the given encoder block are not shared across the plurality of encoder blocks.

19. The non-transitory computer readable medium of claim 17, wherein the instructions that when executed cause the at least one processor to train the attention parameters comprise instructions that when executed cause the at least one processor to:
determine an intermediate output matrix based on a product of a training example among the one or more training corpora and the attention dictionary;
generate a sparse coefficient matrix for each encoder block using the index matrix and the coefficient matrix associated with the encoder block; and
train the sparse coefficient matrix for each encoder block and the attention dictionary.

20. The non-transitory computer readable medium of claim 19, further containing instructions that when executed cause the at least one processor to deploy a trained machine learning model; and
wherein the instructions that when executed cause the at least one processor to deploy the trained machine learning model comprise instructions that when executed cause the at least one processor to:
convert the trained sparse coefficient matrix for each encoder block into an index matrix and a coefficient matrix for the encoder blocks; and
deploy the attention dictionary, the index matrices, and the coefficient matrices to the mobile device.

21. A method comprising:
receiving an input at a mobile device that stores a trained machine learning model, the trained machine learning model comprising a plurality of encoder blocks, an attention dictionary shared across the plurality of encoder blocks, an index matrix for each of the encoder blocks, and a coefficient matrix for each of the encoder blocks; and
performing a linear projection of the input in each of the plurality of encoder blocks using the attention dictionary, the index matrix associated with the respective encoder block, and the coefficient matrix associated with the respective encoder block.

22. The method of claim 21, wherein performing the linear projection comprises:
determining an intermediate output based on a product of the input and the attention dictionary; and
for each of the encoder blocks, determining a product of the intermediate output and coefficients in the coefficient matrix associated with the respective encoder block for columns identified by the index matrix associated with the respective encoder block.
